(19) United States
(12) Patent Application Publication
(10) Pub. No.: US 2023/0413779 A1
(43) Pub. Date: Dec. 28, 2023

(54) Dog Bed Structure with Inclined Transition Insert

(71) Applicant: Petra DeCoteau, Langhome, PA (US)

(72) Inventor: Petra DeCoteau, Langhome, PA (US)

(21) Appl. No.: 18/341,711

(22) Filed: Jun. 26, 2023

Related U.S. Application Data
(60) Provisional application No. 63/356,460, filed on Jun. 28, 2022.

(51) Int. Cl. A01K 1/035

(52) U.S. Cl. CPC A01K 1/0353

(57) ABSTRACT

A dog bed assembly that contains a primary bed structure with a flat base and periphery. A confinement wall is disposed along at least some of said periphery. The confinement wall extends upwardly from the flat base, therein forming a bowl area. A transition cushion is provided within the bowl area. The transition cushion has a sloped surface that extends from the flat base to an elevation that is at least half-way up the confinement wall. The sloped transition cushion has a first edge that faces into the bowl area and an elevated second edge that faces the confinement wall. The first edge contains a convex relief. The elevated second edge conforms to the curvature of the confinement wall.

### RELATED APPLICATIONS

This application claims the benefit of U.S. Provisional application No. 63/356,460, filed Jun. 28, 2022.

### BACKGROUND OF THE INVENTION

### 1. Field of the Invention

In general, the present invention relates to the structure of pet beds. More particularly, the present invention relates to pet beds that have a raised peripheral wall and a cushion structure positioned within the raised peripheral wall.

### 2. Prior Art Description

There are many breeds of dogs. Accordingly, dogs come in a wide variety of shapes and sizes. Depending upon the age and breed of a dog, the length of a dog's neck and the distance from the shoulder to the spine can vary by several inches.

In proportion to body size, dogs have longer necks and longer neck vertebrae than humans. As a result, when a dog is resting, it is difficult for a dog to keep its neck vertebrae aligned with its spine. This is especially true if the dog is resting on its side. Dogs, like people, are typically more comfortable when the neck vertebrae and the remainder of the spine are generally aligned or gently curved. It is for this reason that a dog is very comfortable resting its head on a person's lap or on the body of another dog. Due to the anatomy of the species, dogs are naturally comfortable placing their heads across their front legs as they sleep. This slight elevation of the head keeps the neck of the dog relatively straight, wherein the vertebrae of the neck are aligned with the vertebrae of the spine.

Most dogs do like to sleep on soft surfaces, such as couches and beds. Most dogs also prefer to lean against objects, people, or other dogs as they sleep. Recognizing this instinct in dogs, many dog beds are designed to have a soft bottom and a raised peripheral wall. A dog will lay on the soft bottom of the bed while leaning against the peripheral wall. Such prior art dog beds are exemplified by U.S. Pat. No. 5,136,981 to Barreto and U.S. Patent Application Publication No. 20060254526 to Andriola.

A problem associated with a traditional raised wall dog bed is that the space available within the peripheral wall is limited. As such, when a dog is in the dog bed and leans its body against the peripheral wall, the dog's front legs typically are also pressed against the peripheral wall. This prevents the dog from comfortably placing its head across its front legs. Rather, the dog is forced to place its head on the peripheral wall, which is too high a position, or place its head on the floor of the bed, which is too low of a position.

The present invention addresses this problem by providing a cushion insert for use in a dog bed that has a raised peripheral wall. The cushion insert provides a transitional support that orients and supports the dog's head and neck as it leans against the peripheral wall of the dog bed.

The details of the invention are described and claimed below.

### SUMMARY OF THE INVENTION

The present invention is a dog bed assembly that contains a primary bed structure. The primary bed structure has a flat base with a periphery. A confinement wall is disposed along at least some of said periphery. The confinement wall extends upwardly from the flat base, therein forming a bowl area that is defined by both the flat base and the confinement wall.

A sloped transition cushion is provided and is positioned within the bowl area. The transition cushion has a sloped surface that extends from the flat base to an elevation along the confinement wall that is at least half-way up the confinement wall. The sloped transition cushion has a first edge that faces into the bowl area and an elevated second edge that faces the confinement wall. The first edge contains a convex relief. The elevated second edge conforms to the curvature of the confinement wall.

When a dog lies in the bowl area, the dog's neck and head are slightly inclined on the sloped transition cushion. In this optimal position, the neck vertebrae of the dog align in elevation with the spine vertebrae and the dog can comfortably rest.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is an exploded view of a first exemplary embodiment of a dog bed system;

FIG. 2 shows the exemplary embodiment of FIG. 1 shown in an assembled condition;

FIG. 3 is a cross-sectional view of the transition cushion shown embodiment of FIG. 1, viewed along section line 3-3;

FIG. 4 is a cross-sectional view of the embodiment of FIG. 1, viewed along section line 4-4;

FIG. 5 shows an alternate embodiment of a dog bed system;

FIG. 6 shows the exemplary embodiment of FIG. 5 assembled and in conjunction with a dog; and

FIG. 7 shows an alternate embodiment of a dog bed system with an integrated transition cushion.

### DETAILED DESCRIPTION OF THE DRAWINGS

Although the present invention dog bed system can be embodied in many ways, only a few exemplary embodiments are illustrated. The exemplary embodiments are being shown for the purposes of explanation and description. The exemplary embodiments are selected in order to set forth some of the best modes contemplated for the invention. The illustrated embodiments, however, are merely exemplary and should not be considered limitations when interpreting the scope of the appended claims.

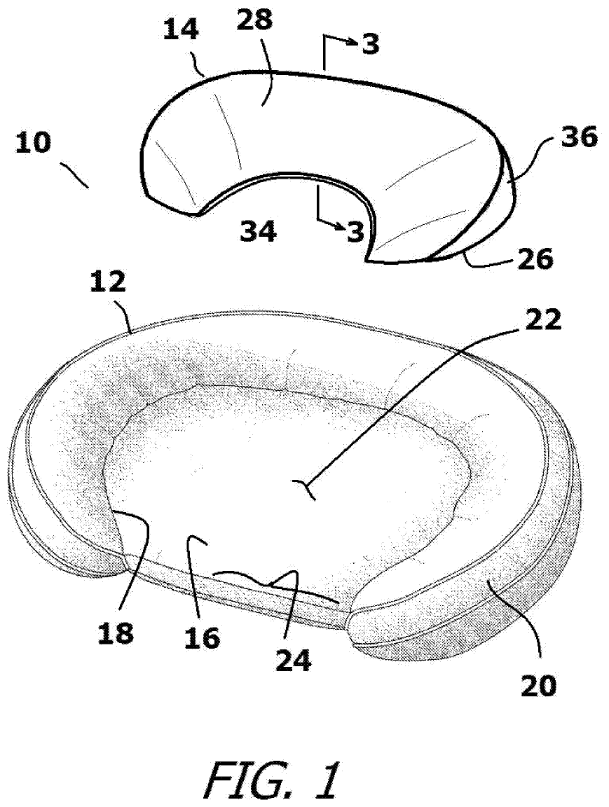

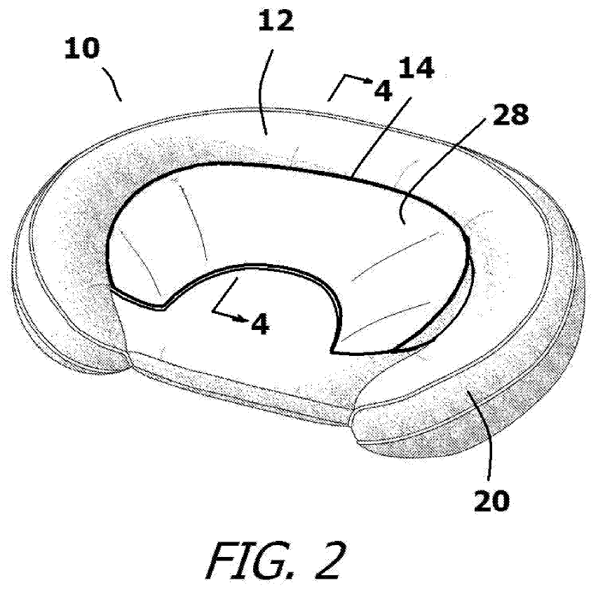

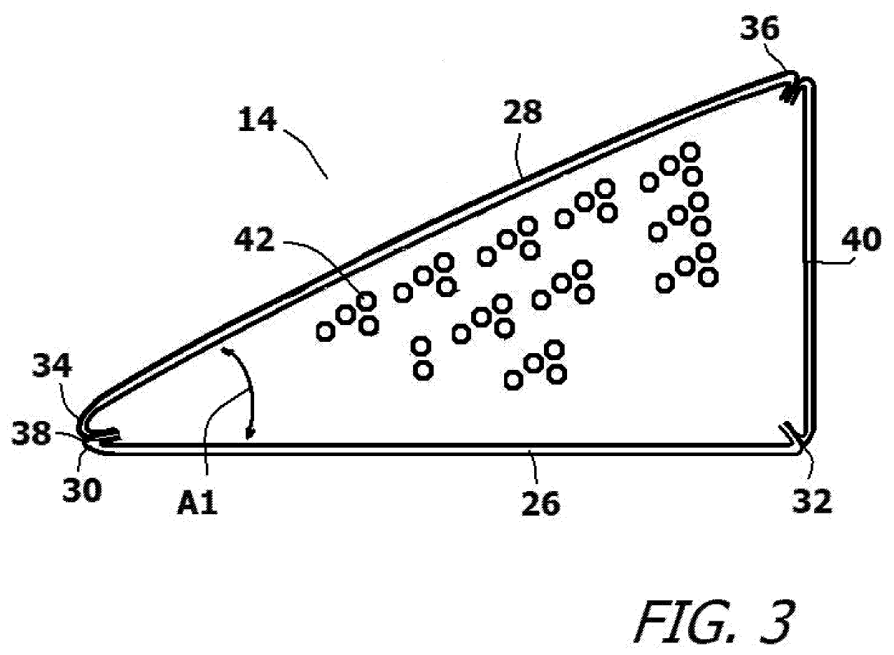

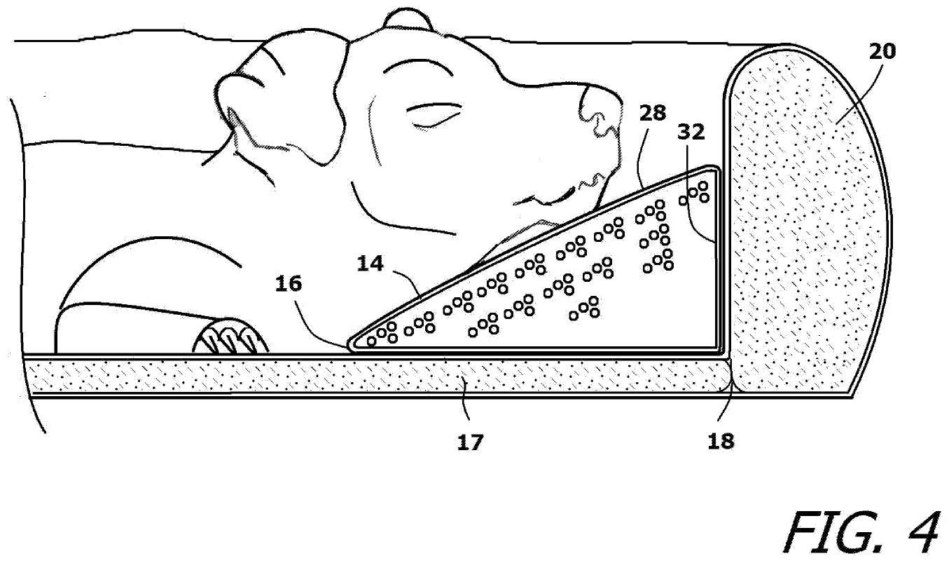

Referring to FIG. 1 in conjunction with FIG. 2, FIG. 3 and FIG. 4, a dog bed system 10 is shown. The dog bed system 10 illustrated includes a traditional dog bed structure 12 and a novel transition cushion 14.

Although shown as separate elements for ease of description, it should be understood that the transition cushion 14 and the dog bed structure 12 can have an integrated construction.

The traditional dog bed structure 12 has a flat base 16. The flat base 16 can contain a thin layer of internal padding 17. The flat base 16 has a periphery 18. The periphery 18 is typically round, elliptical, or rectangular in shape. A padded confinement wall 20 is attached to the periphery 18 of the flat base 16. The padded confinement wall 20 is typically between three inches and eight inches in height. The padded confinement wall 20 follows a circular, elliptical, or rectangular contoured path as it follows the periphery 18 of the flat base 16. The padded confinement wall 20 defines a bowl area 22 in which a dog or other animal is intended to rest. The padded confinement wall 20 can be uniform in height at all points around the bowl area 22. However, many popular dog beds use a confinement wall 20 with an open section 24 or a lowered section that provides easy access for a pet into the bowl area 22.

The transition cushion 14 is a plush construct that is sized to fit within the bowl area 22 of the traditional dog bed structure 12. The transition cushion 14 is generally C-shaped or crescent shape to match the curvature of the padded confinement wall 20 within the bowl area 22 of the primary dog bed 12. The transition cushion 14 conforms to a length of the padded confinement wall 20 within the bowl area 22. The transition cushion 14 has a flat bottom panel 26 and a sloped top panel 28 that are both generally C-shaped. The flat bottom panel 26 rests upon the flat base 16 of the primary dog bed 12. The sloped top panel 28 has an angle of inclination A1 of between 25 degrees and 50 degrees with respect to the flat bottom panel 26.

The flat bottom panel 26 of the transition cushion 14 has a front edge 30 and a back edge 32. Likewise, the sloped top panel 28 has a front edge 34 and a back edge 36. The front edge 34 of the sloped top panel 28 is sewn directly to the front edge 30 of the flat bottom panel 26 along a common front seam 38. Since the sloped top panel 28 is inclined, the back edge 36 of the sloped top panel 28 is elevated above the back edge 32 of the flat bottom panel 26.

A vertical panel 40 is used to interconnect the back edge 36 of the sloped top panel 28 to the back edge 32 of the flat bottom panel 26. The vertical panel 40 has a graduated shape and reaches a maximum height H1 where the sloped top panel 28 is farthest from the flat bottom panel 26. The maximum height H1 is preferably at least half as tall as the maximum height of the padded confinement wall 20, but shorter than the padded confinement wall 20. In this manner, the dog will still be bound by the padded confinement wall 20 when lying upon the transition cushion 14. The transition cushion 14 is densely filled with plush fill 42 or foam. As such, the sloped top panel 28 is soft, but is stiff enough to support the weight of a dog's head.

Referring to FIG. 4 in conjunction with FIG. 1 and FIG. 3, it can be seen that when a dog enters the dog bed system 10, a larger dog's natural instinct is to rest in the bowl area 22 and lean against the padded confinement wall 20. Accordingly, some of the dog's body will come to rest upon the sloped top panel 28 of the transition cushion 14 as the dog leans to its side. Since the sloped top panel 28 of the transition cushion 14 is inclined, gravity will cause the bulk of the dog's body to slide down the sloped top panel 28 and settle onto the flat base 16 of the primary dog bed 12. However, the dog's head and neck will remain on the sloped top panel 28 of the transition cushion 14. The height of the head and heck is approximately the same as if the dog were to rest its head across its front legs. The result is an optimal resting position for the dog. The dog's body is primarily on the low flat base 16 of the primary dog bed 12. Furthermore, the incline of the transition cushion 14 biases the dog's body toward the center of the primary dog bed 12 and away from the padded confinement wall 20. This positions the dog's front legs away from the padded confinement wall 20. The dog's neck and head are slightly inclined on the sloped top panel 28 of the transition cushion 14 and can be readily moved between the sloped top panel 28 and the dog's front legs. In this optimal position, the neck vertebrae of the dog align in elevation with the spine vertebrae and the dog can comfortably rest.

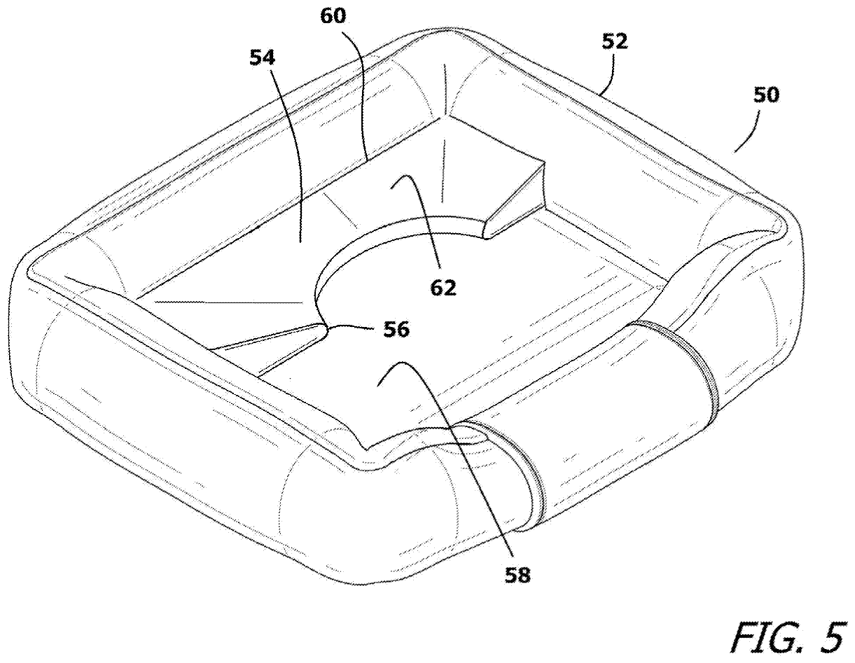

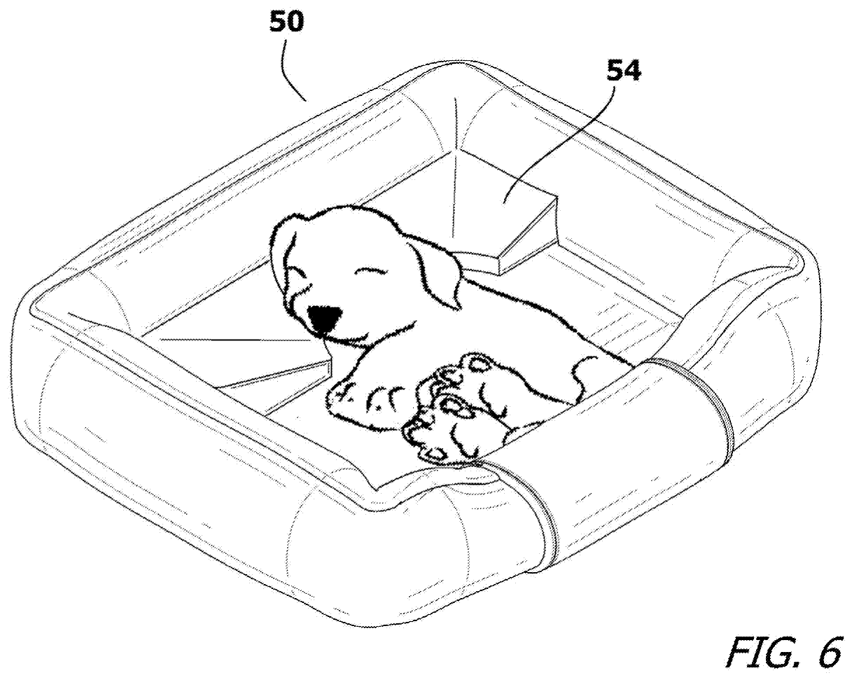

Referring to FIG. 5 and FIG. 6, an alternate embodiment of a dog bed system 50 is shown. The dog bed system 50 has a primary dog bed 52 and a transition cushion 54. The transition cushion 54 has a front edge 56 that touches the flat base 58 of the primary dog bed 52 and an elevated rear edge 60. A sloped top surface 62 extends between the front edge 56 and the elevated rear edge 60.

The purpose of this embodiment is to demonstrate that the primary dog bed 52 can have different shapes and sizes and that the transition cushion 54 can also have different shapes and sizes to conform to the shape of the primary dog bed 52. In all cases, the transition cushion 54 provides a sloping cushioned surface that inclines from the flat base 58.

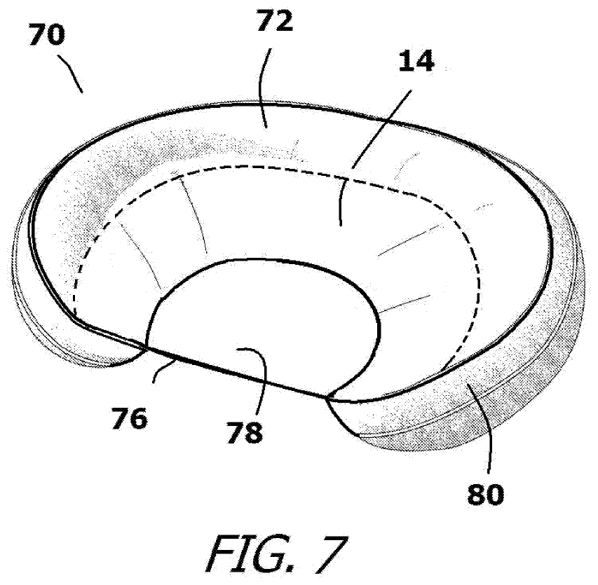

Referring to FIG. 7, a second alternate embodiment of a dog bed system 70 is shown. The dog bed system 70 has a primary dog bed 72 that includes an integrated transition cushion 74. The transition cushion 74 has a front edge 76 that extends from a flat base 78 to an elevation on the peripheral confinement wall 80. Since the transition cushion 74 is integrated into the structure of the dog bed 72, it cannot be removed. However, the transition cushion 74 produces the same results as the separate transition cushions previously described.

It will be understood that the embodiments of the present invention that are illustrated and described are merely exemplary and that a person skilled in the art can make many variations to those embodiments. For instance, the insert can be integrated into the sewn structure of the dog bed. All such embodiments are intended to be included within the scope of the present invention as defined by the appended claims.

What is claimed is:

1. A dog bed assembly, comprising:
a primary bed structure having a flat base with a periphery and a confinement wall disposed along at least some of said periphery, wherein said confinement wall extends upwardly from said flat base, therein forming a bowl area defined by said flat base and said confinement wall;
a transition cushion disposed within said bowl area that has a sloped surface that extends from said flat base to an elevation along said confinement wall that is at least half-way up said confinement wall.

2. The assembly according to claim 1, wherein said transition cushion has a first edge that faces into said bowl area and an elevated second edge that faces said confinement wall.

3. The assembly according to claim 2, wherein said first edge has a concave relief formed therein.

4. The assembly according to claim 3, wherein said sloped surface is crescent shaped.

5. The assembly according to claim 1, wherein said elevated second edge of said transition cushion abuts against said confinement wall along a length of contact.

6. The assembly according to claim 5, wherein said confinement wall follows a contoured path along said length of contact.

7. The assembly according to claim 6, wherein said elevated second edge of said transition cushion conforms to said contoured path of said confinement wall along said length of contact.

8. The assembly according to claim 1, wherein said transition cushion is separate and distinct from said confinement wall and is detachable from said primary bed structure.

9. The assembly according to claim 1, wherein said transition cushion is connected to said confinement wall and said flat base of said primary bed structure.

10. A dog bed assembly, comprising:
a primary bed structure having a flat base with a periphery and a confinement wall disposed along at least some of said periphery,
a sloping surface that extends from a first edge along said flat base to an elevation along said confinement wall that is at least half-way up said confinement wall, wherein said sloping surface has an angle of inclination between 25 degrees and fifty degrees, and wherein said first edge of said sloping surface has a concave relief formed therein.

11. The assembly according to claim 10, wherein said confinement wall and said flat base define a bowl area.

12. The assembly according to claim 10, wherein said transition cushion abuts against said confinement wall along a length of contact within said bowl area.

13. The assembly according to claim 12, wherein said confinement wall follows a contoured path along said length of contact.

14. The assembly according to claim 13, wherein said sloping surface has a rear edge that conforms to said contoured path of said confinement wall along said length of contact.

15. The assembly according to claim 10, wherein said sloping surface is part of a transition cushion that is separate and distinct from said confinement wall and is detachable from said primary bed structure.

16. The assembly according to claim 10, wherein said sloping surface is connected to said confinement wall and said flat base of said primary bed structure.
